(19) United States
(12) Patent Application Publication
(10) Pub. No.: US 2005/0009966 A1
(43) Pub. Date: Jan. 13, 2005

(54) Aqueous fire resistant and smoke suppressing surface coatings

(76) Inventor: John B. Rowen, Southborough, MA (US)

Correspondence Address: John B. Herring;Avtec Industries, Inc., 9 Kane Industrial Drive, Hudson, MA, 01749, US

(21) Appl. No.: 10/912,265

(22) Filed: Aug. 5, 2004

Related U.S. Application Data
(63) Continuation-in-part of application No. 09/521,074, filed on Mar. 7, 2000.

(51) Int. Cl. C08K 5/49; C09K 21/14; C08K 3/34; C08K 3/04; C08K 5/05

(52) U.S. Cl. 524/115; 252/606; 524/495; 524/386; 524/492

(57) ABSTRACT

A surface coating includes fire retarding and smoke suppressing constituents dispersed throughout an essentially non-toxic, water-based adhesive binder. The coating is composed of a mixture of chemical compounds where each constituent falls into one of six functional groups, being: 1) catalyst/initiator; 2) expandable graphite; 3) carbonific, or source of carbon which additionally forms water; 4) blowing agent (a source of non-flammable gases); 5) cement; and, 6) ceramic.

### RELATED APPLICATIONS

This application is a continuation-in-part of U.S. patent application Ser. No. 09/521,074, “Flame Retardant and Smoke Suppressive Additive Powder for Polymeric Thermoplastics and Thermoset Resins,” filed on Mar. 7, 2000 by Schell at al.

### FIELD OF THE INVENTION

This invention relates generally to flame retardant and smoke suppressive compositions, and more particularly to compositions for mixing with adhesive binders.

### BACKGROUND OF THE INVENTION

Commodity construction materials and structural components are cost effective and exhibit acceptable building component properties. However, upon exposure to open flame or high radiant heat, many common building materials exhibit troublesome properties that are inherent with regard to surface flammability, smoke generation and toxicity (FST). Those properties are often subject to prescribed regulatory performance criteria by fire code regulating authorities, particularly when those construction components are to be used in an enclosed environment.

Due to a greater awareness of the destructive and life threatening consequences of structures that were not designed to address stringent fire safety standards, recommendations by the top engineers in the United States will alter the way buildings are designed and what materials are used. The call for improved fire safety standards is under investigation by agencies such as the National Institute of Standards and Technology, i.e., NIST. Federal recommendations after disasters have traditionally resulted in substantial changes to safety codes enacted by state and local governments from New York to California. For example, after the San Fernando earthquake in 1971, many western states adopted a uniform building code to make buildings more resistant to quake damage. In view of the tragic consequences that befell the World Trade Center in September of 2001, new interest in passive fireproof, fire retardant and smoke suppressive coating technology is at the crux of the call for new safety standards and building codes.

Commercially available for decades, insulative and fire resistant coatings have been applied to building materials with menacing and troublesome problems when exposed to open flame or high radiant heat. For instance, nearly all fireproofing in modern steel-reinforced buildings is a mixture of mineral fibers, concrete-like materials called binders and water. The mixture is sprayed onto columns and beams, where it dries and sticks. If a fire breaks out, in theory, the fireproofing insulates the structural steel to prevent it from heating to the point at which it becomes soft and unable to bear a load. As evidenced by the swift World Trade Center collapse, its brittle nature and low adhesive properties demonstrate it is inadequate for secure fire safety engineering practices. Another example of a fireproof coating in widespread use is solvent-based intumescent coatings. Those solvent-based coatings have numerous coating binders varying from simple elastomeric rubber adhesives to sophisticated two-part thermoset resin binders. Although most have satisfactory adhesion for general industrial use, they vary dramatically in fireproofing and smoke suppression characteristics. These characteristics, or properties, are surface flammability and flame spread; smoke generation and obscuration characteristics; and, the toxicity of the combustion products generated by pyrolysing polymer binders and brominated polymeric fire retardants. Solvents required for processing of these coatings are typically toluene, methyl ethyl ketone, xylene, styrene, methyl methacrylate or acetone, or a combination thereof. Environmental and health safety code governing authorities are increasingly limiting the quantity of such hazardous airborne pollutants permitted for both liberation into the environment and exposure times for end users and applicators.

U.S. Pat. No. 3,293,327 describes the production of bicyclic phosphites, phosphonates, thiophosphates, and selenophosphates. Those compositions are said to be stabilizers for vinyl halide resins, and are said to be useful as heat stabilizers for vinyl chloride resin, and as antioxidants for fats and oils.

Intumescent, fire-retardant coating compositions containing carbonifics, film-forming binders and phosphorous materials are well known in the art. U.S. Pat. Nos. 3,562,197; 3,513,114; 4,009,137; 4,166,743 and 4,247,435 disclose such compositions containing ammonium polyphosphates as the phosphorous containing material.

U.S. Pat. No. 3,654,190 discloses an intumescent paint comprising a resinous binder, a blowing agent, a phosphorous containing material, a source of chlorine a solvent, an anti-settling agent, a pigment and a surfactant.

U.S. Pat. No. 3,969,291 describes the use of an amide polyphosphate condensate as a fire-retardant additive in an intumescent coating composition. U.S. Pat. No. 3,914,193 discloses the similar use of a crystalline form of melamine pyrophosphate.

U.S. Pat. No. 4,801,625, describes a flame resistant composition having (1) an organic polymeric substance in intimate contact with (2) a bicyclic phosphorous compound, and (3) a gas producing compound. The patent is silent on the use of bicyclic compounds to attain smoke suppressed flame retardant thermoset compositions.

U.S. Pat. No. 5,356,568 describes a solvent-based heat-resistant and fire-retardant coating containing carbonifics, film-forming binders, and phosphorous materials. Also described is an application where the coating is sprayed on steel and aluminum plates using a gravity flow gun. Not described are any smoke retardant properties, nor the use of the coating with resins or polymer plastics.

Historically, as fire retardant and fireproof coatings have been found to exhibit undesirable characteristics that can lead to a multitude of problems, i.e., brittleness; poor adhesion; egregious smoke generation; biologically toxic species of thermoset resin combustion byproducts such as brominated compounds and suspect carcinogens.

Therefore, it is desired to provide a non-toxic additive powder and an adhesive binder. More particularly, for the reasons stated above, it is specifically desired to provide a finished product that does not include any of the following classes of compounds:

Brominated compounds, including decabromodiphenyl ether (DBPE, Deca-BDE), octabromodiphenyl ether (Octa-BDE), pentabromophenyl ether (Penta-BDE), hexabromocyclododecane (HBCD), decadbromobiphenyl ether (DeBBE) as well as other polybrominated biphenyls (PBB), tetrabromo phthalic anhydride and all related aliphatic and aromatic brominated compounds.

Heavy metals or metallic compounds such as the bromine synergist antimony trihydroxide (ATO).

For the purpose of the present invention, any prior-art article of manufacture containing any compounds in any of the above classes are considered irrelevant as they yield products with undesirable physical and flame-retardant characteristics that are inconsistent with current building and life safety regulatory standards, and are physiologically toxic.

### SUMMARY OF THE INVENTION

The invention provides a surface coating having fire retarding and smoke suppressing constituents dispersed throughout an essentially non-toxic, water-based adhesive binder. In this novel composition, the coating includes an additive powder that is a mixture of chemical compounds dispersed in the binder where each constituent falls into one of six functional groups, being: 1) catalyst/initiator; 2) expandable graphite; 3) carbonific, or source of carbon which additionally forms water; 4) blowing agent (a source of non-flammable gases); 5) cement; and, 6) ceramic.

### DETAILED DESCRIPTION OF THE PREFERRED EMBODIMENTS

The invention provides a fire-retardant and smoke-suppressing coating. This novel composition includes an additive powder and an adhesive binder. The additive powder can be mixed with curable or hardenable resins, polymeric film forming plastics, and other thermally oxidizable petrochemical based compounds and derivatives. The powder includes a carbonific material, a heat activated blowing agent, a heat activated carbonic material, a phosphate material, and other inorganic material.

The additive powder, when combined with a film forming curable or hardenable adhesive binder, forms a mixture where the additive powder is about 20-65%, by dry or cured weight, of the mixture. The binder can be styrenic, olefinic, acrylic, cellulosic, polyester, or polyamide such as are commonly used in the manufacture of fiberglass reinforced structures and moldable plastics.

This new coating contains virtually no volatile organic compounds (VOCs) or hazardous air pollutants (HAPs).

The powdered composition according to the invention is “active.” By being active, the composition has a latent ability to intumesce or foam when a specific temperature is reached. This is due to the nature of a blowing agent, which is a part of the composition. In a preferred embodiment, that temperature of flame or heat retardation is 350 degrees Centigrade. At this temperature and above, the cured or hardened resin/composite structure resists combustion, self-extinguishes without the direct application of a flame extinguisher, and produces a substantially smaller quantity of less-toxic smoke than similar prior-art materials.

In a preferred embodiment of the invention, the composition of the additive powder, according to weight of ingredient classes, is as follows.

| Ingredient Class | Wgt. % Range |
|---|---|
| a) catalyst | 30.0 to 41.0 |
| b) carbonific | 22.0 to 29.0 |
| c) blowing agent | 15.5 to 17.5 |
| d) cementitious inorganic binder | 21.0 to 25.0 |
| e) ceramic | 2.50 to 5.00 |

The ingredients of the additive powder are mixed and blended at ambient (room) temperature until fully incorporated into a uniform, homogeneous composition. The additive in its final form is a white fine powder that can be added to an adhesive binder.

The ingredients of the additive powder can also be dispersed in an aqueous binder. When dispersed in an aqueous binder, the ingredients include, by percent dry additive weight: a carbonific material 5.0-6.0%; a heat activated blowing agent 7.5-9.0%; a heat activated halogen material 6.0-9.0% which forms a fire extinguishing halogen gas under heat; a phosphate material 15.0-17.0% which forms water and phosphorous acid when reacting with one or more of the remaining ingredients in the powder under heat; and an inorganic binder 11.0-15.0%.

Each class of compounds contributes a specific property to the formulation that is advantageous to the success of the invention in yielding a reduced propensity for materials coated with the invention so treated to bum, smoke, generate toxic gases, or transmit heat.

Catalyst

The ingredients in the catalyst class can include phosphorous containing materials such as ammonium polyphosphate and tris (betachloroethyl) phosphate at approximately a 9:1 ratio. Under the influence of heat from a fire or otherwise, the catalyst decomposes, yielding phosphoric acid.

The reactive phosphoric acid produced by the breakdown of the catalyst compound reacts with both the amine function of melamine and the hydroxy function of the carbonific, as described below, to produce water, carbon dioxide, urea and ammonia. In addition, under the applied and generated heat, the organic components of the resin composite, as described below, are degraded producing and contributing to an insulating layer of char.

In other embodiments, the phosphate material is selected from the group consisting of ammonium polyphosphate, tris(beta-chloroethyl) phosphate, guanidine phosphate, urea phosphate, melamine phosphate, monoammonium phosphate, diammonium phosphate, and mixtures thereof.

Expandable Flake Graphite

In the preferred embodiment, the expansion ratio of the graphite crystal is 70:1. Expandable flake graphite is produced by the chemical or electrolytic oxidation treatment of natural crystalline flake graphite. When exposed to rapid, intense heating, the expandable flake graphite expands to many times its original volume. Expansion and expanded density properties are dependent upon the source of the original graphite and the nature of the treatment. Exfoliation, e.g., the separation of flakes and layers, is affected by the sudden volume increase of graphite “compounds”, e.g., compounds that are the result of the above mentioned treatment, trapped between the stacked layers of the graphite crystal. Particles of crystalline expandable graphite exfoliate with an increase in volume of between 40 and 300 times. This crystal expansion is parallel with the “C” crystallographic axis. As described herein this invention, other formula constituents retard the volume of expansion, converting the reactant structure to a very bulky structure that tends to cling to itself.

Carbonific

In the preferred embodiment, the primary ingredient of the carbonific class of material is dipentaerythritol or tripentaerythritol. The carbonific, when heated, will produce a carbon char layer that insulates the underlying uncombusted resin and finished structure from greater thermal damage. It should be understood, that the resin itself, with which the flame retardant additive powder is mixed, can be a secondary source of carbon, and thus, also a carbonific. In the case where the resin decomposes to a carbon rich byproduct, the amount of primary carbonific can accordingly be adjusted downward when the resin is to be relied upon as a carbonific for the combustion process.

In other embodiments of the invention, the carbonific material can be selected from the group consisting of dipentaerythritol, pentaerythritol, tripentaerythritol, polyurethane, phenol, triethylene glycol, resorcinol, inositol, sorbitol, dextrin, and starch.

Blowing Agent

The blowing agent is primarily comprised of melamine. Heat decomposition of the melamine produces ammonia, urea, water, carbon dioxide, etc. These gases swell and expand the volume of the forming carbonaceous char. This expansion produces a multi-cellular, swollen thermal char layer, which insulates the underlying substrate from additional heat.

In other embodiments, the heat activated blowing agent is selected form the group consisting of urea, butyl urea, benzene sulfonyl-hydrazide, melamine phosphate, melamine polyphosphate, melamine cyanurate, melamine borate, chloroparaffin, guanidine and glycine.

Cementitious Constituent

The cementitious constituent reacts in the presence of generated steam vapor. These compounds proceed through a hydration reaction and imparts a cementitious, e.g., cement, characteristic to the carbonaceous structure as the surface swells. This cementitious characteristic limits the expansion of the graphite and imparts structural integrity to the carbon char layer.

This heat resistant inorganic material can include a mixture of suitable heat resistant cementitious compounds, such as silica flour. However, in the preferred embodiment the cementitious constituent is calcium aluminate cement, which undergoes a dissolution precipitation reaction when exposed to water or water steam vapor.

Ceramic

The heat resistant ingredients of the ceramic class of materials are preferably solid ceramic, hollow ceramic or treated silica spheres, or combination there-of. The preferred ceramic is made of spheres about 10 to 500 micron in diameter.

Other embodiments can include quartz, mica and other inorganic materials, which possess high emissivity values.

Adhesive Binder

The inventive constituent is an adhesive binder, which provides adherence of the fire-retarding and smoke-suppressing powder to a material substrate. The adhesive binder can be either a resin that is synthetically produced or a naturally occurring film forming plant latex having the property of coagulating when exposed to ambient air at room temperature.

In the preferred embodiment the adhesive binder is a one part, air dried, cross-linking polymer of modified acrylic emulsion, such as styrenated acrylic emulsion polymers containing unsaturated carboxylic groups that crosslink. Alternatively, the binder can include thermoset resins that require initiation to crosslink at ambient room temperature, or thermoset resins that require initiation to crosslink at elevated temperature.

The binder can also be a dispersion of a thermoplastic polymer, a thermosetting polymeric resin, or any film-forming polymeric resin capable of coalescing to a film. Examples of such polymers include aqueous dispersions of polyamide polymers, polyethylene polymers, polypropylene polymers, and certain polyester polymers. When coalescence at room temperature is desired, lower molecular weight oligomers of the above polymers may be employed, or traditional film-forming polymers such as polyester polymers, vinyl ester polymers, vinyl ester/ethylene copolymers, acrylate polymers, styrene/acrylate copolymers, styrene/butadiene copolymers, and a variety of natural and synthetic latexes and the like may be used.

The adhesive binder of the preferred embodiment is self-dispersing, but may be dispersed with the aid of solvent based or aqueous based materials such a solvent, dispersant, surfactant, or suspending agent material or combination thereof. The binder may also incorporate fibrous reinforcements, and is capable of wetting and coating glass rovings and woven glass rovings; threads, yarns and fabrics of both nature and synthetic materials and combinations thereof; non-woven fabrics; insulating assemblies; and combinations of said fabrics and insulating assemblies.

The film forming adhesive resin binder is an aqueous, i.e., water, based polymer dispersion that contains only traces, or virtually no volatile organic compounds (VOCs), or hazardous air pollutants (HAPs). Spraying, dipping, brushing or rolling-on the adhesive composition can accomplish application of the water based composition.

Reaction to Heat Source

The invention is pyrolytic, e.g., undergoes chemical change caused by heat. Upon exposure to high heat, as in a fire, the active materials operate stepwise in the following orderly format:

In the earliest phase of the fire retardant activity reaction, the catalyst/initiator decomposes to release a strong acid by-product, whereupon the by-product dehydrates the pyrolysing adhesive binder resin and reacts with the carbonific to form initiator based esters. After a series of reactions and decompositions, the original acid by-product of the catalyst decomposition is released for further reaction to continue the above-described cycle. Unsaturated compounds are formed with subsequent charring. During this phase, the expandable crystalline graphite decomposes to form a matrix of elemental carbon platelets that hold the growing structure resulting from the catalyst reaction in place until the remaining functional groups contribute to a fire retarding and smoke suppressing layer. As the layer grows, particulate smoke and soot is entrapped within the carbon platelet matrix, reducing particulate smoke.

Reduced to an elemental carbon mass, the formed carbon platelet structure cannot make a contribution as a fuel source or generate smoke.

In unison with the graphite reaction, the catalyzed carbonific begins to decompose, as the temperature rises, along a much different route and at a lower temperature than would have occurred for a non-catalyzed carbonific. A functional component in the carbonific binds with the dehydrated acrylic binder to form a contributing carbonaceous quantity within the char. Additionally, decomposition of the carbonific constituents produces fire snuffing carbon dioxide and water. The original strong acid by-product of the catalyst decomposition continues to be regenerated for the reaction cycle to continue.

The blowing agent then begins to decompose, yielding non-flammable gases and additional char. The surface of the forming structural grows larger in volume forming a swollen insulative heat shield.

The cementitious constituents perform several functions as the structure develops, including adding rigidity and strength to the expanded carbon char; reflecting infrared (IR) radiances; and, suppressing smoke and afterglow.

The ceramic constituent, dispersed throughout and supported by the carbon/cementitious structure also performs several functions, including: insulating the under-laminate from heat; absorbing IR radiances; reradiating the IR away from the coated material by emissivity; and, in combination with the cementitious/char component structure, keeps even higher temperatures and high velocity pressure gradients from penetrating into the under-laminate structure.

Effect of the Invention

Upon application of the surface film coating to a combustible substrate, the invention will substantially and sharply reduce the propensity of the coated substrate to combust, generate toxic smoke or transmit heat when exposed to open flame or high radiant heat. Upon exposure to fire, the coating will intumesce, e.g., swell, and form an open-cell, ceramic/graphite/cementitious barrier. This swollen structure will dramatically shield the underlying substrate from an open flame or radiant heat source; it will allow the substrate to withstand even higher temperatures and increased pressure gradiants; and, allow heat dissipation by atmospheric convection.

The invention is pliable after curing, and adheres to all common building material substrates, i.e., wood, steel, gypsum board, cement, tile, foam, fiberglass, and coated materials. Further, the invention is non-flammable and intumesces to produce a highly insulative layer; produces very little smoke upon exposure to open flame or high radiant heat; contains an aqueous based non-toxic polymer binder with no active toxic constituents; produces no significant toxic fumes upon combustion; contains no brominated compounds; contains cementitious, i.e., cement, constituents; contains exfoliating crystalline graphite; and, contains ceramic for increased emissivity.

Test Results

Standard testing methods and protocols are used by many authorities to determine fire-hazard and surface-burning characteristics of building materials, e.g., ASTM E-84 Standard Test Method for Surface Burning Characteristics of Building Materials. It is accepted that test results with higher values for flame spread and smoke obscuration are indicative of a greater fire hazard and more dangerous smoke production. Comparative results for the ASTM protocol are listed in Table A.

TABLE A
ASTM E-84 Test Results for a Coated Substrate

| Property | Invention | Typical Prior Art |
|---|---|---|
| Flame Spread Ratio | 15 | 25.0 |
| Smoke Obscuration | 100 | 980+ |
| Toxicity | None | High |

As seen from the Table A, the flame spread ratio and smoke obscuration results for the invented material surpass, and in terms of life safety characteristics, are superior to that of a typical prior-art result. This is a significant reduction. More surprisingly and importantly, no toxic by-products are produced by the invented material and a significant amount of the registered obscuration is water, by chemical design.

Smoke obscuration measurement by the ASTM E-84 protocol is based upon the attenuation, i.e., change in concentration, of a white light beam by smoke accumulating in a chamber. Results are derived from measuring optical density as absorbance within the chamber. The photometric scale used to measure smoke by this method is similar to the optical density scale for human vision. Hence, obscuration can result from such combustion byproduct species as particulate matter, e.g., soot, or condensed gas, e.g., water vapor.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A fire retarding and smoke suppressing coating containing a dispersed composition in an aqueous binder, comprising, by percent dry additive weight:
a carbonific material 5.0-6.0%;
a heat activated blowing agent 7.5-9.0%;
a heat activated halogen material 6.0-9.0% which forms a fire extinguishing halogen gas under heat;
a phosphate material 15.0-17.0% which forms water and phosphorous acid when reacting with one or more of the remaining ingredients in the powder under heat; and
an inorganic binder 11.0-15.0%.

2. The coating of claim 1, further comprising expandable graphite.

3. The coating of claim 1, further comprising mica and expandable mica.

4. The coating of claim 1 wherein the binder may be dried at either ambient or elevated temperature.

5. The coating of claim 1 wherein the binder is curable at ambient temperature.

6. The coating of claim 1 wherein the binder is a synthetically produced binder.

7. The coating of claim 1 wherein the binder is a naturally occurring film forming plant latex exhibiting the property to coagulate at ambient temperature upon exposure to air.

8. The coating of claim 1 wherein the binder is a dispersion of a thermoplastic polymer.

9. The coating of claim 1 wherein the binder is a thermosetting polymeric resin.

10. The coating of claim 1 wherein the binder is any film-forming polymeric resin capable of coalescing to a film.

11. The coating of claim 1 wherein the binder is capable of wetting and coating glass rovings and woven glass rovings; non-woven glass fabrics, or any combination thereof; as well as, both synthetic and natural fibers and fabrics and any combination thereof .

12. The coating of claim 1 wherein the binder is capable of incorporating fibrous reinforcements.

13. The coating of claim 1 wherein the binder is self-dispersing.

14. The coating of claim 1 wherein the phosphorous-based catalyst is selected from the group consisting of ammonium polyphosphate, tris(beta-chloroethyl) phosphate, guanidine phosphate, urea phosphate, melamine phosphate, monoammonium phosphate, and diammonium phosphate.

15. The coating of claim 1 wherein the carbonific material is selected from the group consisting of pentaerythritol, dipentaerythritol, tripentaerythritol, pentaerythritol polyurethane, phenol, triethylene glycol, resorcinol, inositol, sorbitol, dextrin, and starch.

16. The coating of claim 1 wherein the inorganic cementitious binder is selected from the group consisting of calcium aluminate cement.

17. The coating of claim 1, further comprising:
a ceramic material, 2.50 to 5.00%, in which the ceramic material is selected from the group consisting of ceramic spheres, silica spheres or a combination thereof.

18. The coating of claim 1 wherein the expandable graphite has a carbon content of 80 to 99.8%.

19. The coating of claim 1 wherein the resin-based binder cures by uninitiated crosslinking.

20. The coating of claim 1 wherein the resin-based binder includes styrenated acrylic emulsion polymers containing unsaturated carboxylic groups that crosslink.

21. The coating of claim 1 wherein the resin-based binder includes thermoset resins that require initiation to crosslink at ambient room temperature.

22. The coating of claim 1 wherein the resin-based binder includes thermoset resins that require initiation to crosslink at elevated temperature.

23. A fire retarding and smoke suppressing coating, comprising:
an aqueous adhesive binder;
a phosphorus based catalyst;
a carbonific;
a producer of fire snuffing gases;
a blowing agent;
a cementitious material; and
ceramic spheres.
